(19) United States
(12) Patent Application Publication
(10) Pub. No.: US 2020/0246940 A1
(43) Pub. Date: Aug. 6, 2020

(54) Grinding Disc with Fixing Part for One-Touch Holder

(71) Applicant: Jang Hee LEE, Gimhae-si (KR)

(72) Inventor: Jang Hee LEE, Gimhae-si (KR)

(21) Appl. No.: 16/471,468

(22) PCT Filed: Nov. 21, 2017
(86) PCT No.: PCT/KR2017/013246

§ 371 Date: Apr. 24, 2020

(30) Foreign Application Priority Data
Dec. 21, 2016 (KR) 1020160175585

(51) Int. Cl. B24D 18/00; B24B 23/02; B24B 45/00; B29C 45/14

(52) U.S. Cl. CPC B24D 18/0009; B29C 45/1459; B24B 45/006; B24B 23/022

(57) ABSTRACT

The present invention relates to a grinding disc used in a grinder for cutting a workpiece by generating a rotation power by a motor or air pressure and, more specifically, to a grinding disc with a fixing part for a one-touch holder, which includes an abrasive part which comes into contact with a workpiece, and a fixing part formed in the center of the abrasive part for attachment and detachment with respect to a grinder, wherein the fixing part is formed by injection molding so as to improve the bonding force with the abrasive part and can be attached to or detached from the grinder by a one-touch method.

### CROSS REFERENCE TO RELATED APPLICATION

The present application claims the benefit of Korean Patent Application No. 10-2016-0175585 filed in the Korean Intellectual Property Office on Dec. 21, 2016, and the PCT application number PCT/KR2017/013248 filed on Nov. 21, 2017 on the entire contents of which are incorporated herein by reference.

### BACKGROUND OF THE INVENTION

### Field of the Invention

The present invention relates to a grinding disc used in a grinder for cutting a workpiece by generating a rotation power by a motor or air pressure and, more specifically, to a grinding disc with a fixing part for a one-touch holder, which includes an abrasive part which comes into contact with a workpiece, and a fixing part formed in the center of the abrasive part for attachment and detachment with respect to a grinder, wherein the fixing part is formed by injection molding so as to improve the bonding force with the abrasive part and can be attached to or detached from the grinder by a one-touch method.

### Background Art

Generally, as shown in FIG. 1, a grinder generates rotation power by a motor or air pressure, transmits the generated power to a rotation shaft 2 formed on one side of the grinder 1, and is coupled to an abrasive material 6 such as a grinding disc or a grinding stone so as to be used to machine or cut the surface of a workpiece.

In the case of a prior art grinding disc, as shown in FIG. 2, a through hole 6a is formed in the center of such an abrasive material 6 and injection-molded plastic materials, that is, an upper fixing plate 4 and a lower fixing plate 5 are fitted in the upper and lower portions of the through hole 6a so as to be fixed to the abrasive material 6, forming a grinding disc 8.

Briefly explaining the manufacturing process of such a prior art grinding disc 8, an adhesive 7 is applied to the end face of the lower fixing plate 5 and the adhesive 7 is also applied to the lower surface of the abrasive material 6 around the through hole 6a in a state, in which the lower fixing plate 5 is placed such that the protrusion portion of the lower fixing plate 5 faces upwards, so that the lower fixing plate 5 is adhered and fixed to the abrasive material 6. Then, the adhesive 7 is applied to the upper surface of the abrasive material 6 around the through hole 6a and the adhesive is also applied to the end surface and the inner circumferential surface of the upper fixing plate 4 so that the upper fixing plate 4 is adhered and fixed to the lower fixing plate 5 by the adhesive 7, thereby manufacturing the grinding disc.

Such a prior art grinding disc has a disadvantage that since the upper fixing plate 4 and the lower fixing plate 5 are fixed with the adhesive 7, the manufacturing process becomes cumbersome and complicated, thereby increasing the manufacturing costs. In addition, if the adhesive force of the adhesive deteriorates, there is a high possibility of defective products.

Particularly, when the bonding operation is performed in the state of a high water content, the adhesive force of the adhesive 7 is lowered due to the high moisture, so there is a concern about defective products. Besides, as the time passes, the adhesive force of the adhesive gradually decreases, reducing the service life. In a serious case, the abrasive material 7 is separated from the upper and lower fixing plates 4, 5 and thus the abrasive material 7 rotating at a high speed may cause a safety accident.

Particularly, in order to prevent such a safety accident, there is a case where a fixing member such as a bolt is fixed between the upper and lower fixing plates 4 and 5, thereby complicating the manufacturing process and raising the manufacturing costs.

There is another problem that the manufacturing environment of a workplace is poor due to the use of the adhesive.

As a prior art related to such a grinding disc, there is a grinder assembly proposed in Japanese Patent Laid-open Publication No. 10-2011-0023596.

The proposed grinder assembly includes a grinder having a back pad coupled to a rotation shaft so as to rotate, and a grinding disc coupled to one surface of the back pad, wherein the back pad and the grinding disc are provided with quick-change coupling means for enabling the fast exchange of the grinding disc from the back pad and the quick-change coupling means includes a protrusion means protruded from one surface of the back pad and a coupling key hole formed in the grinding disc such that the protrusion means protruded from one surface of the back pad is coupled thereinto. However, the proposed grinder assembly has a problem that there is a concern that the shape of the grinding disc is changed during the grinding operation or the strength of the grinding disc is lowered since the through hole is formed in the center of the grinding disc and the fixing part of the grinding disc is inserted and fixed into the through hole.

As another prior art, there is a manufacturing method of a grinding disc proposed in Japanese Patent Laid-open Publication No. 11-320423.

According to this proposed manufacturing method of a grinding disc, an abrasive material is provided to the inside of upper and bottom molds, the abrasive material is inserted into a groove portion formed on the mold when the mold is assembled, and an injection material is injected into the cavity of the mold through a gate, thereby forming a boss portion. However, the proposed manufacturing method of a grinding disc has a problem that the strength of the grinding disc is inevitably lowered since the shape of the grinding disc is changed by the mold. Particularly, the shape change of the abrasive material causes a portion having a relatively thin thickness and thus the durability is inevitably lowered.

### PRIOR ART DOCUMENTS

### Patent Documents

(Patent Document 0001) Korean Patent Laid-open Publication No. 10-2011-0023596

(Patent Document 0002) Japanese Patent Laid-open Publication No. 11-320423

### SUMMARY OF THE INVENTION

Accordingly, the present invention has been made to solve the above-mentioned problems occurring in the prior arts, and it is an objective of the present invention to provide a grinding disc with a fixing part for a one-touch holder, which can be attached to or detached from a grinder in a one-touch manner, comprising an abrasive part which comes in contact with a workpiece and a fixing part formed in the center of the abrasive part so as to be attached to or detached from a grinder, wherein the fixing part is formed by injection molding so as to increase the bonding force with respect to the abrasive part.

Furthermore, it is another objective of the present invention to provide a grinding disc with a fixing part for a one-touch holder, in which a fixing part is formed larger than the diameter of a hole formed in an abrasive part and has three fixing protrusions formed on one side of the fixing part and a stopper protrusion is formed on one side of each of the fixing protrusions so that the fixing part can be attached to or detached from a one-touch holder fixed and coupled to a grinder.

Besides, it is a further objective of the present invention to provide a grinding disc with a fixing part for a one-touch holder, in which an abrasive part has a stepped part formed in the center thereof so as to be thinner than the thickness of the abrasive part and a fixing part is formed by the size of the stepped part so that the fixing force of the fixing part with respect to the abrasive part is improved.

### SUMMARY OF THE INVENTION

According to the present invention for achieving the above objectives, in a grinding disc of a grinder used for generating rotation power by a motor or air pressure and cutting a workpiece, there is provided a grinding disc with a fixing part for a one-touch holder, characterized in that the grinding disc includes an abrasive part which comes in direct contact with a workpiece for polishing and a fixing part provided for the attachment and detachment with respect to a one-touch holder fixed to the grinder, the fixing part is formed by injection molding so as to surround parts of upper and lower surfaces in the center of the abrasive part, and the injection molding is carried out in such a manner that after the abrasive part is placed in the mold, the mold is coupled forming a predetermined space around a center part and an injection material is injected and cured in the space so that the fixing part is made of the injection material and simultaneously the injection material penetrates into pores in the abrasive part such that the bonding force between the abrasive part and the fixing part is improved.

### Effect of the Invention

The grinding disc with a fixing part for a one-touch holder, according to the present invention, comprises the abrasive part which comes in contact with a workpiece and the fixing part formed in the center of the abrasive part so as to be attached to or detached from a grinder, wherein the fixing part is formed by injection molding so as to increase the bonding force with respect to the abrasive part and can be attached to or detached from a grinder in a one-touch manner. Furthermore, the fixing part is formed larger than the diameter of a hole formed in the abrasive part and has three fixing protrusions formed on one side of the fixing part and a stopper protrusion is formed on one side of each of the fixing protrusions so that the fixing part has a remarkable effect of being readily attached to or detached from a one-touch holder fixed and coupled to a grinder. Besides, the abrasive part has a stepped part formed in the center thereof so as to be thinner than the thickness of the abrasive part and the fixing part is formed by the size of the stepped part. Therefore, there is a remarkable effect that the fixing force of the fixing part with respect to the abrasive part is improved.

### BRIEF DESCRIPTION OF DRAWINGS

FIG. 1 shows the configuration of a prior art grinder,

FIG. 2 shows an exploded structure of a prior art grinding disc,

FIG. 3 is an exemplary view showing the configuration of an embodiment of the present invention,

FIG. 4a is a plane view of FIG. 3,

FIG. 4b is a bottom view of FIG. 3,

FIG. 5 is a cross-sectional view of FIG. 4a, taken along line A-A,

FIG. 6 is a view showing a manufacturing process according to the present invention,

FIG. 7 is an exemplary view showing another embodiment of the present invention,

FIG. 8 and FIG. 9 show states of use of the present invention,

FIG. 10 is an exemplary view showing a grinding disc according to another embodiment of the present invention,

FIG. 11 is a plane view of FIG. 10, and

FIG. 12 to FIG. 14 show further embodiments of the present invention.

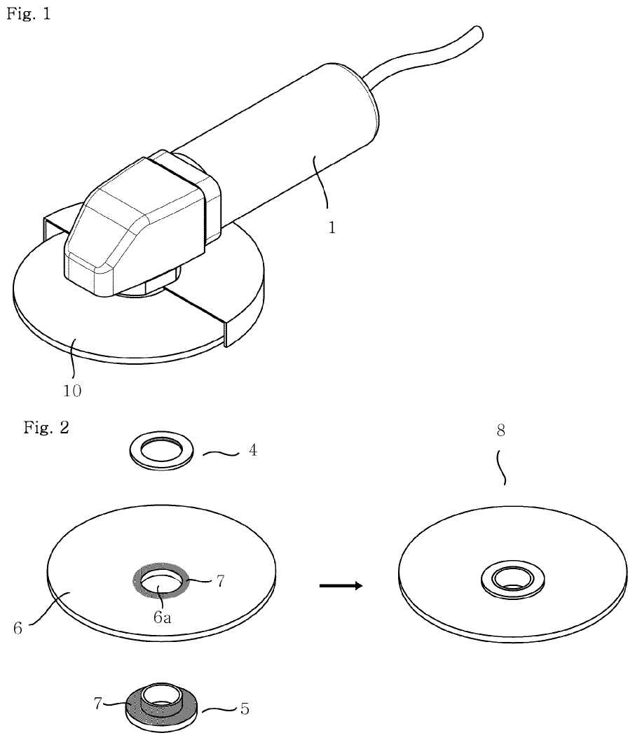

Brief Explanation of Reference Symbols

| | |
|---|---|
| 1: grinder | 2: rotation shaft |
| 3: one-touch holder | 3a: insertion protrusion |
| 3b: fitting protrusion | 3c: outer peripheral part |
| 3d: inner peripheral part | |
| 4: upper fixing plate | |
| 5: lower fixing plate | |
| 6: abrasive material | 6a: through hole |
| 7: adhesive | 8: grinding disc |
| 9: coupling bolt | |
| 10: grinding disc | |
| 11: abrasive part | 12: through hole |
| 13: stepped part | 14: cut groove |
| 15: fixing part | 16: fixing protrusion |
| 17: stopper protrusion | |
| 18: runner | 19: gate |
| 20: concave groove | 21: fixing groove |
| 22: coupling groove | |
| UM: upper mold | BM: bottom mold |

### DETAILED DESCRIPTION OF THE PREFERRED EMBODIMENT

The present invention relates to a grinding disc used in a grinder for cutting a workpiece by generating a rotation power by a motor or air pressure and, more specifically, to a grinding disc with a fixing part for a one-touch holder, which includes an abrasive part which comes into contact with a workpiece, and a fixing part formed in the center of the abrasive part for attachment and detachment with respect to a grinder, wherein the fixing part is formed by injection molding so as to improve the bonding force with the abrasive part and can be attached to or detached from the grinder by a one-touch method.

Hereinafter, preferred embodiments of the present invention will be described in detail with reference to the accompanying drawings.

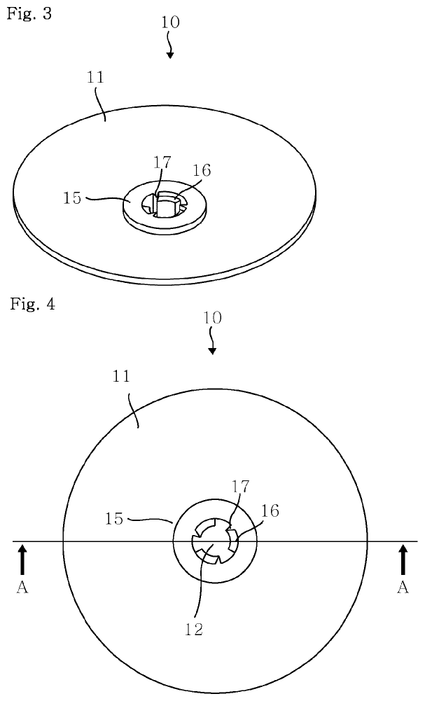

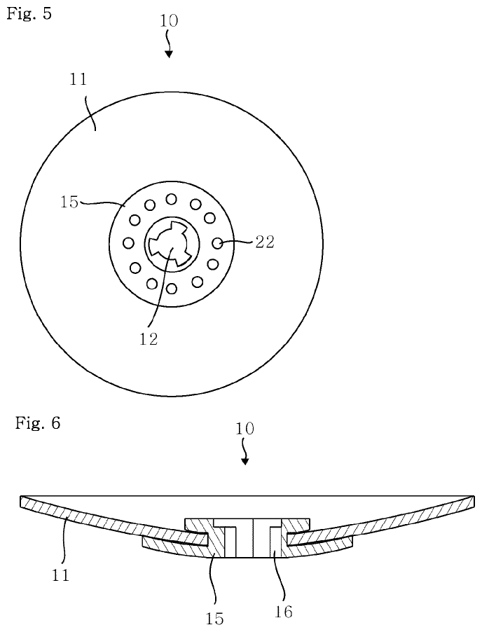

FIG. 3 is an exemplary view showing the configuration of an embodiment of the present invention, FIG. 4a is a plane view of FIG. 3, FIG. 4b is a bottom view of FIG. 3, FIG. 5 is a cross-sectional view of FIG. 4a, taken along line A-A, and FIG. 6 is a view showing a manufacturing process according to the present invention. In a grinding disc of a grinder used for generating rotation power by a motor or air pressure and cutting a workpiece, a grinding disc 10 with a fixing part for a one-touch holder, according to the present invention, includes an abrasive part 11 which comes in direct contact with a workpiece for polishing and a fixing part 15 provided for the attachment and detachment with respect to a one-touch holder 3 fixed to the grinder 1, wherein the fixing part 15 is formed by injection molding so as to surround parts of upper and lower surfaces in the center of the abrasive part 11, the injection molding is carried out in such a manner that after the abrasive part 11 is placed in the mold, the mold is coupled forming a predetermined space around a center part, an injection material is injected and cured in the space so that the fixing part is made of the injection material and simultaneously the injection material penetrates into pores in the abrasive part 11 such that the bonding force between the abrasive part 11 and the fixing part 15 is improved.

First, the grinder 1, to which the present invention can be applied, generates rotation power of a rotation shaft 2 by a motor accommodated in the grinder 1 or generating rotation power by air pressure, may be a hand grinder to be used in hand or a general grinder placed on the floor, and is used for polishing a surface of a workpiece or cutting a workpiece.

The abrasive part 11 is made of an abrasive material such as a grinding stone which comes in direct contact with a workpiece to perform a grinding process, wherein an alumina abrasive material or a silicon carbide abrasive material may be used as the abrasive material and the abrasive material can be classified into a coarse-grained abrasive material and a fine-grained abrasive material depending on particle size and is usually made by compression-molding granules of small particles.

A through hole 12 is formed in the center of the abrasive part 11 through the abrasive part 11 and this through hole 12 is formed by a press mold or the like during the preparing of the abrasive part 11, wherein the center of the through hole 12 is preferably coincident with the center axis of rotation of the abrasive part 11.

The fixing part 15 is provided to the through hole 12 so as to be attached to or detached from the grinder 1, and the fixing part 15 is formed by injection molding so as to surround parts of the upper and lower surfaces of the abrasive part in the center of the abrasive part, as shown in FIG. 5 and FIG. 6.

That is, the fixing part 15 is formed by injecting the injection material of a gel state through a gate 19 formed in an upper mold UM and cooling the injection material, after the abrasive part 11 is inserted into an insert injection mold and the upper mold UM is operated to be engaged with a bottom mold BM, such that the injection material is used in the formation of the fixing part 15 and simultaneously inserted into the plurality of pores formed in the abrasive part 11 and thus the abrasive part 11 and the fixing part 15 come into close contact with each other, increasing the bonding force.

The abrasive part 11 that can be used in the present invention has a plurality of pores formed therein and the size of the pores is preferably in the range of 0.1 and 2.0 mm.

That is, if the pore size is less than 0.1 mm, it is difficult for the injection material to penetrate deeply inside the pores. To the contrary, if the pore size is more than 2.0 mm, the strength of the abrasive part 11 itself may be lowered and thus the strength of the grinding disc may be lowered due to the volume reduction upon cooling of the injection material.

The pore size defined herein means the average pore size and it is natural that there may be some pores having a difference from the proposed value.

After the abrasive part 11 is placed in the mold and the injection part is injected to form the fixing part 15, it is possible to reduce some of the moisture contained in the fixing part 15 by keeping the fixing part 15 at room temperature or high temperature.

That is, the injection raw material, which is the material of the fixing part 15, has a certain moisture content and thus the strength of the fixing part 15 may be lowered. Therefore, when the fixing part 15 is kept for a certain time at room temperature or high temperature, the moisture contained in the fixing part 15 is evaporated and thus the volume of the fixing part 15 is reduced, thereby increasing the bonding force between the fixing part 15 and the abrasive part 11.

Furthermore, the fixing part 15 is formed larger than the diameter of the hole formed in the abrasive part 11 and has three fixing protrusions 16 formed on one side of the fixing part 15 and stopper protrusions 17 formed on one side of each of the fixing protrusions 16 so that the fixing part 15 can be attached to or detached from the one-touch holder 3 fixed and coupled to the grinder 1.

Meanwhile, two or more coupling holes 22 are formed in one side of the fixing part 15 at equal intervals and fitting protrusions 3b of the one-touch holder 3 are inserted into the coupling holes 22 such that the grinding disc is prevented from being rotated arbitrarily during the polishing by the grinding disc.

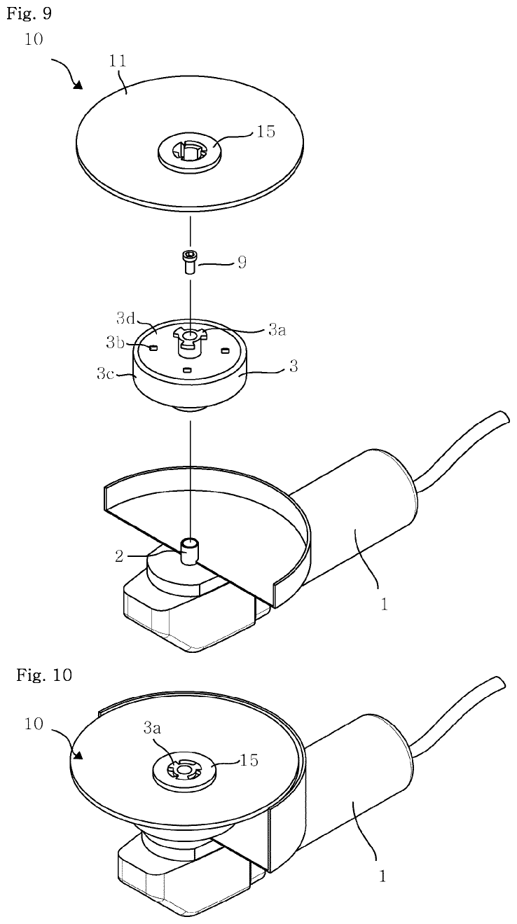

That is, the fixing part 15 according to the present invention is not a general ring-shaped fixing plate but can be formed with the three fixing protrusions 16 such that the fixing part 15 can be coupled in a one-touch manner to the one-touch holder 3 shown in FIG. 8 with the fixing protrusions 16, wherein the one-touch holder 3 is fixed and coupled to the grinder 1 by means of a coupling bolt 9.

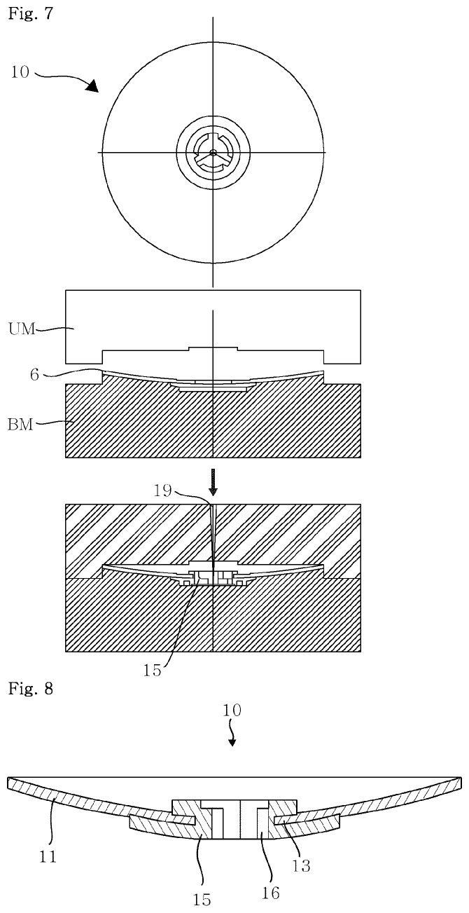

Considering this connection method in more detail, if the insertion protrusions 3a of the one-touch holder 3 are fitted with the grooves formed on the fixing part 15 in a state, in which the fitting protrusions 3b of the one-touch holder 3 are fitted with the coupling grooves 22 of the fixing part 15, and the grinding disc 10 is turned in a clockwise direction or a counterclockwise direction around the rotation axis of the grinding disc 10, then the fixing protrusions 16 formed on the fixing part 15 and the insertion protrusions 3a formed on the one-touch holder 3 are engaged with each other so that the grinding disc 10 is completely fixed to the one-touch holder 3 that is fixed and coupled to the grinder 1 as shown in FIG. 7.

Herein, in the one-touch holder 3, the insertion protrusions 3a and an outer peripheral part 3c are rotated but an inner peripheral part 3d, on which the fitting protrusions 3b are formed, is not rotated. In addition, force for pushing the inner peripheral part 3d all the time is applied by a spring provided between the outer peripheral part 3c and the inner peripheral part 3d such that the fitting protrusions 3b can be maintained in a rotated state.

Furthermore, the fixing protrusion 16 has a thickness that gradually increases from a point, at which the coupling of the insertion protrusion 3a of the one-touch holder 3 is started, to a point, at which the coupling of the insertion protrusion 3a is completed, that is, from the starting point of the fixing protrusion 16 to the stopper protrusion 17. Therefore, as the insertion protrusion 3a rotates, the force pushing against the fixing protrusion 16 increases, thereby increasing the fixing force of the grinding disc.

Meanwhile, since the stopper protrusion 17 is formed on one side of the fixing protrusion 16, the grinding disc 10 is prevented from rotating further and the fixing part 15 is prevented from being arbitrarily separated from the one-touch holder 13 during processing of the workpiece. When replacing the grinding disc 10, the grinding disc 10 can be separated from the one-touch holder 3 by turning the grinding disc 10 in the opposite direction such that the engagement between the fixing protrusions 16 of the fixing part 15 and the insertion protrusions 3a of the one-touch holder 3 is released.

Referring to FIG. 7, the abrasive part 11 according to the present invention may have a stepped part formed in the center thereof so as to be thinner than the thickness of outer portion of the abrasive part 11 and the fixing part 15 may be formed by the size of the stepped part.

That is, the thickness of the entire abrasive part 11 is not formed to be uniform. Instead, the stepped part 13 having a relatively thin thickness is formed in the central part of the abrasive part 11 so as to have a constant radius and the fixing part 15 is formed only by the size of the stepped part 13 such that the contact area between the abrasive part 11 and the fixing part 15 is increased improving the fixing force and the reduction of the abrasive area of the abrasive part 11, which is caused by the fixing part 15, can be prevented to some extent, wherein the circumferential surface of the fixing part 15 is brought into close contact with the step surface of the abrasive part 11 so that the fixing force is further improved by the increased area, and the height of the fixing part 15, that is, the distance between the outermost end face of the fixing part 15 and the abrasive part 11 is relatively decreased so that the interference of the polishing operation by the fixing part 15 can be eliminated.

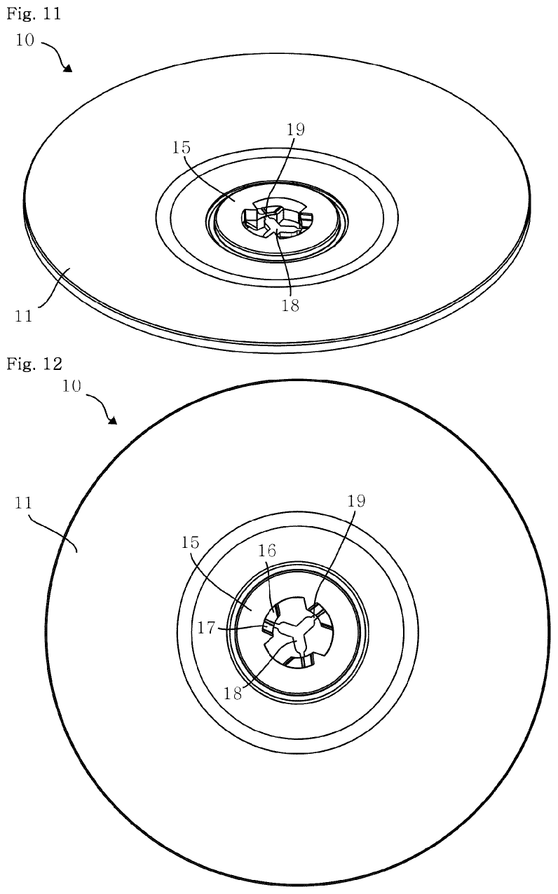

FIG. 10 is an exemplary view showing a grinding disc according to another embodiment of the present invention and FIG. 11 is a plane view of FIG. 10. Referring to FIG. 10 and FIG. 11, the fixing part 15 has a runner 18 and a gate 19 formed in the injection process of the fixing part 15 and the runner 18 and the gate 19 can be formed to be fixed to or released from the one-touch holder 3 that is fixed and coupled to the grinder 1.

When the fixing part 15 is injection-molded by inserting the abrasive part 11 into the injection mold, fuel is sufficiently injected to the runner 18 and the gate 19, which are the passages through which the fuel is injected for the injection of the fixing part 15, and cooling is performed in this state so that the shapes of the runner 18 and the gate 19 remain in the fixing part 15.

A grinding disc product is manufactured as the runner 18 and the gate 19 are left in the fixing part 15 and then the runner 18 and the gate 19 are separated when the grinding disc 10 is fitted into the one-touch holder 3 for use by a user. Therefore, a product with the runner 18 and the gate 19 remaining in the fixing part 15 of the grinding disc 10 is proved to be a new product which has never been used.

In order to facilitate the separation of the runner 18 and the gate 19 during the coupling of the one-touch holder 3, the shape of the gate 19 is preferably formed to be narrower than the cross section of the runner 18, wherein it is preferable that the cross-sectional area of the gate 19 is preferably between 2 and 5 when the cross-sectional area of the runner 18 is 10.

If the cross-sectional area of the gate 19 is less than 2 with respect to the cross-sectional area of the runner, which is 10, the cross-sectional area of the gate 19 is too small to introduce the injection material and thus the injection molding process requires much time. Simultaneously, there is a fear that products may be destroyed arbitrarily during storage. To the contrary, if the cross-sectional area of the gate 19 exceeds 5, the gate 19 may not be well separated during the coupling of the one-touch holder 3. Therefore, it is preferable to maintain the above ratio.

FIG. 12 shows a further embodiment of the present invention. Referring to FIG. 12, at least one cut groove 14 is formed in the abrasive part 11 and a part of the fixing part 15 is inserted into the cut groove 14 during the injection molding process, thereby improving the bonding force between the abrasive part 11 and the fixing part 15.

That is, since the cut groove 14 is formed through a part of the abrasive part 11, when the fixing part 15 is injected in an insert manner, the cut groove 14 is filled with the injection material so that the fixing part 15 is formed. Therefore, the bonding force between the abrasive part 11 and the fixing part 15 is further improved. In this case, when a workpiece is processed by using the grinding disc 10, the abrasive part 11 and the fixing part 15 are not arbitrarily separated from each other.

The cut groove 14 may be formed in a “T” shape as shown in FIG. 12.

That is, the cut groove 14 is not formed in the shape of a simple straight line extending from the center of the grinding disc 10 in a corner direction. By forming the cut groove 14 in a “T” shape, a machining load applied to the grinding disc 10 can be more stably sustained when the workpiece is cut, wherein the upper portion of the “T” shape faces a circumferential direction, that is, in a rotation direction so that the force for enduring the cutting load becomes stronger.

Even though the cut groove 14 is formed on the outside of the fixing part 15 so as to be seen from the outside in the illustrated embodiment, it is also possible to form the cut groove 14 directly below the fixing part 15 so as not to be seen from the outside.

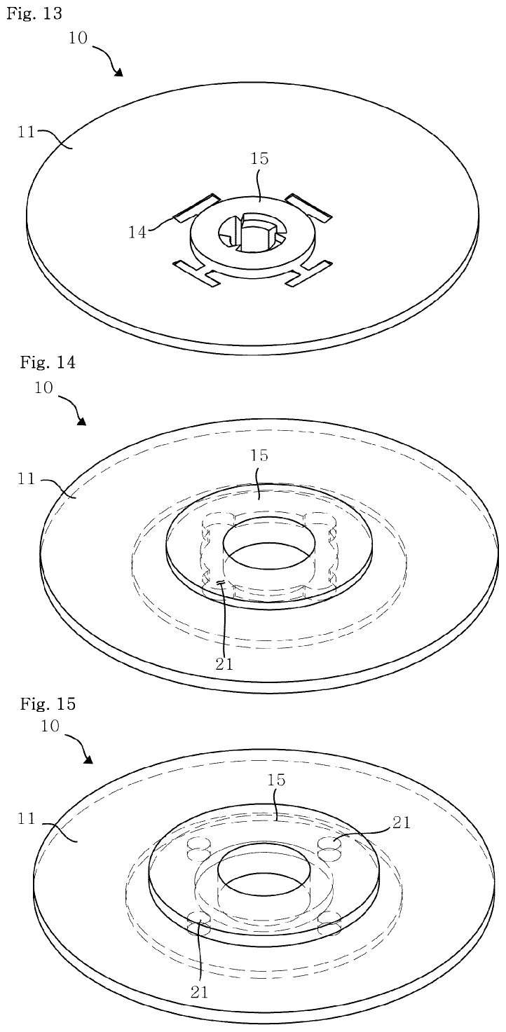

FIG. 13 and FIG. 14 show further embodiments of the present invention. Referring to FIG. 13 and FIG. 14, a concave groove 20 may be formed to be concave at a predetermined depth in the through hole 12 of the abrasive part 11 or at least one fixing groove 21 may be formed around the through hole 12.

That is, the concave groove 20 and the fixing groove 21 are also injection-molded in a state, in which the fixing part 15, as the cut groove 14 so that the fixing force is improved. As a result, the force to withstand the cutting load on the workpiece is improved and the abrasive part 11 is not separated from the fixing part 15 during use, thereby enhancing the stability.

Consequently, the grinding disc with a fixing part for a one-touch holder, according to the present invention, comprises the abrasive part which comes in contact with a workpiece and the fixing part formed in the center of the abrasive part so as to be attached to or detached from a grinder, wherein the fixing part is formed by injection molding so as to increase the bonding force with respect to the abrasive part and can be attached to or detached from a grinder in a one-touch manner, the fixing part is formed larger than the diameter of the hole formed in the abrasive part and has the three fixing protrusions formed on one side of the fixing part, the stopper protrusion is formed on one side of each of the fixing protrusions so that the fixing part has a remarkable effect of being readily attached to or detached from a one-touch holder fixed and coupled to a grinder, the abrasive part has the stepped part formed in the center thereof so as to be thinner than the thickness of the abrasive part, and the fixing part is formed by the size of the stepped part, thereby exhibiting a remarkable effect of improving the fixing force of the fixing part with respect to the abrasive part.

What is claimed is:

1. In a grinding disc (10) of a grinder (1) used for generating rotation power by a motor or air pressure and cutting a workpiece, a grinding disc with a fixing part for a one-touch holder, characterized in that:
the grinding disc (10) includes an abrasive part (11) which comes in direct contact with a workpiece for polishing and a fixing part (15) provided for the attachment and detachment with respect to a one-touch holder (3) fixed to the grinder (1);
the fixing part (15) is formed by injection molding so as to surround parts of upper and lower surfaces in the center of the abrasive part (11);
the injection molding is carried out in such a manner that after the abrasive part (11) is placed in the mold, the mold is coupled forming a predetermined space around a center part, an injection material is injected and cured in the space so that the fixing part (15) is made of the injection material and simultaneously the injection material penetrates into pores in the abrasive part (11) such that the bonding force between the abrasive part (11) and the fixing part (15) is improved;
the fixing part (15) is formed by injecting the injection material of a gel state through a gate (19) formed in an upper mold (UM) and cooling the injection material, after the abrasive part (11) is inserted into an insert injection mold and the upper mold (UM) is operated to be engaged with a bottom mold (BM), such that the injection material is used in the formation of the fixing part (15) and simultaneously inserted into the plurality of pores formed in the abrasive part (11) and the abrasive part (11) and the fixing part (15) come into close contact with each other, increasing the bonding force;
the fixing part (15) is formed larger than the diameter of a through hole (12) formed in the abrasive part (11) and has three fixing protrusions (16) formed on one side of the fixing part (15) and stopper protrusions (17) formed on one side of each of the fixing protrusions (16) so that the fixing part (15) can be attached to or detached from a one-touch holder (3) fixed and coupled to the grinder (1); and
the fixing protrusion (16) has a thickness that increases from a point, at which the coupling of the insertion protrusion (3a) of the one-touch holder (3) is started, to a point, at which the coupling of the insertion protrusion (3a) is completed, that is, from the starting point of the fixing protrusion (16) to the stopper protrusion (17).

2. The grinding disc with a fixing part for a one-touch holder according to claim 1, wherein two or more coupling holes (22) are formed in one side of the fixing part (15) at equal intervals and fitting protrusions (3b) of the one-touch holder (3) are inserted into the coupling holes (22) such that the grinding disc is prevented from being rotated arbitrarily during the polishing by the grinding disc.

3. The grinding disc with a fixing part for a one-touch holder according to claim 1, wherein a plurality of pores are formed in the abrasive part (11), and the size of the pores is in the range of 0.1 and 2.0 mm.
